(19) United States
(12) Patent Application Publication
(10) Pub. No.: US 2024/0170808 A1
(43) Pub. Date: May 23, 2024

(54) BATTERY CELL INCLUDING CURRENT COLLECTING STRUCTURE AND BATTERY DEVICE INCLUDING THE SAME

(71) Applicant: SK On Co., Ltd., Seoul (KR)

(72) Inventors: John Cronin, Jericho, VT (US); Suk Chan KIM, Daejeon (KR); Soo Min PARK, Daejeon (KR); Hyung Ju PAIK, Daejeon (KR); Hae Ryong JEON, Daejeon (KR)

(21) Appl. No.: 18/359,870

(22) Filed: Jul. 27, 2023

Related U.S. Application Data
(60) Provisional application No. 63/427,648, filed on Nov. 23, 2022.

(51) Int. Cl. H01M 50/533; H01M 50/103; H01M 50/15; H01M 50/176; H01M 50/534; H01M 50/548; H01M 50/55

(52) U.S. Cl. CPC H01M 50/533; H01M 50/103; H01M 50/15; H01M 50/176; H01M 50/534; H01M 50/548; H01M 50/55; H01M 2200/20

(57) ABSTRACT

A battery cell is provided. The battery cell includes an electrode assembly including an active material and a foil, a case accommodating the electrode assembly, a cap assembly connected to the case and including a terminal, and a current collecting structure connecting the foil to the terminal.

### CROSS-REFERENCE TO RELATED APPLICATIONS

This patent document claims the benefits of U.S. Provisional Patent Application No. 63/427,648 filed on Nov. 23, 2022, the disclosure of which is incorporated herein by reference in its entirety.

### TECHNICAL FIELD

The present disclosure relates to a battery cell including a current collecting structure and a battery device including the same. More particularly, the present disclosure relates to a battery cell including a current collecting structure capable of reducing a heating value by reducing resistance of the battery cell.

### BACKGROUND

Heat may be generated in prismatic battery cells due to charging or discharging of battery cells. Performance of battery cells may deteriorate due to heat accumulated in battery cells. In addition, a short circuit may occur inside battery cells due to the generated heat, and ignition may occur in battery cells. A structure of battery cells for reducing heat generation inside battery cells has been studied.

### SUMMARY

An electrode assembly may include a portion coated with an active material and an uncoated portion not coated with an active material and electrically connected to an external terminal. However, when current passes through the uncoated portion, resistance may increase and heat generation may occur due to a current bottleneck.

An increase in resistance and local heat generation may cause a decrease in capacity of a battery cell or a decrease in lifespan of the battery cell.

Present disclosure may be implemented in some embodiments to provide a battery cell capable of reducing heat generation by using a current collecting structure capable of reducing resistance.

In the present disclosure, a battery cell may include an electrode assembly including an active material and a foil, a case accommodating the electrode assembly, a cap assembly connected to the case and including a terminal, and a current collecting structure connecting the foil to the terminal.

According to an embodiment, the foil may include a plurality of anode foils and a plurality of cathode foils. The terminal may include an anode terminal and a cathode terminal. The current collecting structure may include a first current collecting structure connected to the plurality of anode foils and the anode terminal and a second current collecting structure connected to the plurality of cathode foils and the cathode terminal.

According to an embodiment, the current collecting structure may include a clamping portion connected to the foil and a connection portion extending from the clamping portion and contacting the terminal.

According to an embodiment, the foil may be formed to be at least partially folded, and the current collecting structure may be connected to the folded foil.

According to an embodiment, the foil may include an anode foil including a first uncoated portion and a second uncoated portion and a cathode foil including a third uncoated portion and a fourth uncoated portion. The current collecting structure may include a first current collecting structure connected to the anode foil and a second current collecting structure connected to the cathode foil.

According to an embodiment, the first current collecting structure may include a first anode current collecting structure connected to the first uncoated portion and a second anode current collecting structure connected to the second uncoated portion and spaced apart from the first anode current collecting structure. The second current collecting structure may include a first cathode current collecting structure connected to the third uncoated portion and a second cathode current collecting structure connected to the fourth uncoated portion and spaced apart from the first cathode current collecting structure.

According to an embodiment, the terminal may include an anode terminal connected to the first anode current collecting structure and the second anode current collecting structure, and a cathode terminal connected to the first cathode current collecting structure and the second cathode current collecting structure.

According to an embodiment, the current collecting structure may be formed of a conductive metal.

According to an embodiment, the cap assembly may include a first cap assembly connected to a first end portion of the case and including a first terminal, and a second cap assembly connected to a second end portion of the case opposite to the first end portion and including a second terminal. The current collecting structure may include a first current collecting structure connected to the first terminal and a second current collecting structure connected to the second terminal.

According to an embodiment, the cap assembly may include a base plate attached to the case, a first terminal at least partially exposed to the outside of the base plate, and a second terminal spaced apart from the first terminal and at least partially exposed to the outside of the base plate. The current collecting structure may include a first current collecting structure connected to the first terminal and a second current collecting structure connected to the second terminal.

According to an embodiment, the cap assembly may include a base plate attached to the case and an insulator at least partially located between the base plate and the terminal.

According to an embodiment, the cap assembly may include a vent guard connected to a venting portion and the base plate and protecting the venting portion.

According to an embodiment, the foil may include a plurality of anode foils and a plurality of cathode foils. The current collecting structure may include a first current collecting structure connected to the plurality of anode foils and a second current collecting structure connected to the plurality of cathode foils. The terminal may include an anode terminal including a first anode terminal at least partially exposed to the outside of the battery cell and a second anode terminal connected to the first anode terminal and the first current collecting structure and a cathode terminal including a first cathode terminal at least partially exposed to the outside of the battery cell and a second cathode terminal connected to the first cathode terminal and the second current collecting structure.

According to an embodiment, the current collecting structure may include a first clamping portion configured to bring end portions of the plurality of anode foils into close contact with each other and a second clamping portion configured to bring end portions of the plurality of cathode foils into close contact with each other.

In the present disclosure, a battery device including the battery cell may be provided.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIGS. 2A, 2B, and 2C are views illustrating an upper cap assembly according to an embodiment.

FIGS. 3A to 3F are a view illustrating an assembly process of an upper cap assembly and an electrode assembly according to an embodiment.

FIGS. 4A to 4F are a view illustrating an assembly process of an electrode assembly, a jelly roll bag, and a can according to an embodiment.

FIGS. 5A and 5B are views illustrating a connection between a jelly roll and an upper cap assembly according to an embodiment.

FIG. 6A is a view illustrating a foil roll and die-cutting process according to an embodiment.

FIG. 6B illustrates an electrode plate connected to a current collecting structure and including an active material and a foil, according to an embodiment.

FIG. 7 illustrates an electrode plate connected to a current collecting structure and including an active material and a foil, according to an embodiment.

FIG. 8 illustrates an electrode plate connected to a current collecting structure and including a folded foil, according to an embodiment.

FIG. 9 illustrates an electrode plate including a plurality of uncoated portions, according to an embodiment.

FIG. 10 is a schematic diagram of a battery cell, according to an embodiment.

FIG. 11 is a schematic diagram of a battery device including a battery cell, according to an embodiment.

### DETAILED DESCRIPTION

Embodiments of the present disclosure will be more fully described below with reference to the accompanying drawings, in which like symbols indicate like elements throughout the drawings, and embodiments are illustrated. However, embodiments of the claims may be implemented in many different forms and are not limited to the embodiments described herein. The examples given herein are non-limiting and are only examples among other possible examples.

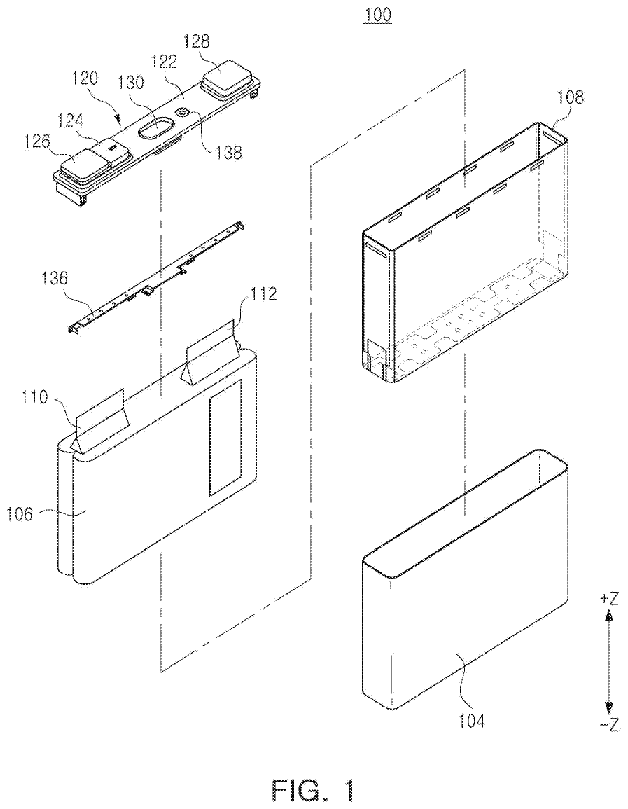

FIG. 1 is an exploded perspective view of a battery cell according to an embodiment.

Referring to FIG. 1, a battery cell 100 may be a prismatic cell. Prismatic cells are widely used in the powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof.

The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness, and tolerance. The can 104 may be wrapped with cell cover tape.

A jelly roll 106 includes a stacked anode, cathode, and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll 106 electrode assembly is included inside a polymer jelly roll bag 108 sealed inside the can 104.

Each jelly roll 106 includes a cathode foil 112 formed of aluminum. The aluminum foil is coated with the electrode slurry. A first operation of electrode manufacturing is a slurry mixing process in which an active raw material is combined with a binder, a solvent, and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency, and life cycle of the prismatic battery cell 100. The electrode should go through a calendaring process in which electrode porosity and twist are controlled by compressing the coated electrode sheet to a uniform thickness and density.

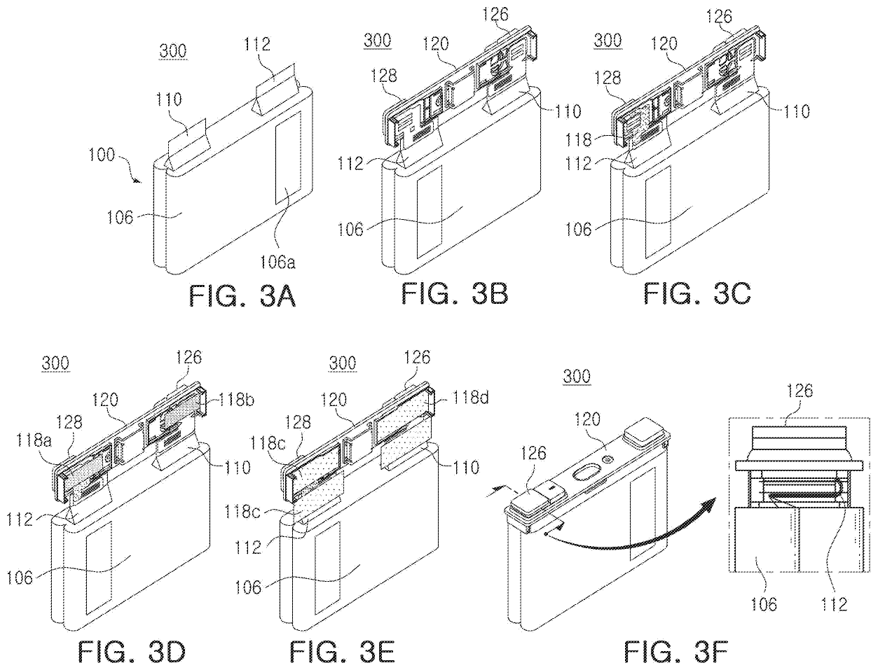

Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have an upper cap assembly 120 welded or otherwise bonded to the top of the can 104. The upper cap assembly 120 may include a base plate 122 attached to the can 104. The base plate 122 isolates the inside and outside of the cell by welding with the can 104. The base plate 122 may serve as a rigid support structure for elements within the upper cap assembly 120. The upper cap assembly 120 may include a plurality of upper insulators 124 to insulate the base plate 122. The upper insulator 124 may prevent leakage of an electrolyte from the prismatic battery cell 100. Additionally, the upper insulator 124 may isolate the can 104 from the cathode foil 112 and prevent penetration of moisture and gases from the outside of the cell. A portion of the upper insulator 124 may protect a current interrupting device. The upper cap assembly 120 includes a cathode terminal 128 electrically connecting the inside and outside of the prismatic battery cell 100. The upper cap assembly 120 includes an anode terminal 126 electrically connecting the inside and outside of the prismatic battery cell 100.

The upper cap assembly 120 may include a venting portion 130 allowing exhaust gases from the prismatic battery cell 100 to be discharged in a controlled direction and at a controlled pressure. The upper cap assembly 120 may include a vent guard 132 protecting the venting portion 130 from the inside of the prismatic battery cell 100 in order to prevent the venting portion 130 from malfunctioning. The upper cap assembly 120 may include an overcharge safety device 134 preventing an external current from being introduced using an internal gas pressure of the prismatic battery cell 100. The upper insulator 124 may be multi-component. In some embodiments, side portions of the upper insulator 124 may be mounted on the edges of the can 104 and the upper cap assembly 120. An electrolyte cap 138 may seal an electrolyte solution inside the prismatic battery cell 100. The upper cap assembly 120 may be referred to as a cap plate or a cap assembly.

The battery cell 100 may include an insulator 136 located between the upper cap assembly 120 and the can 104. In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case.

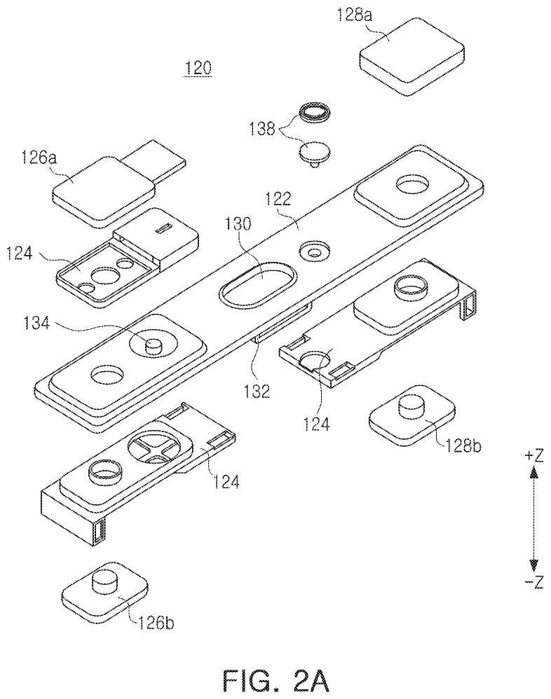

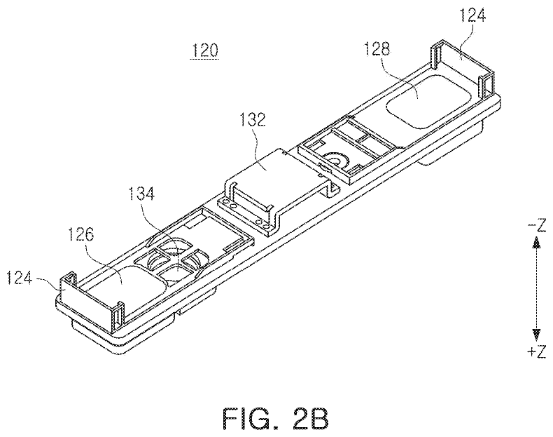

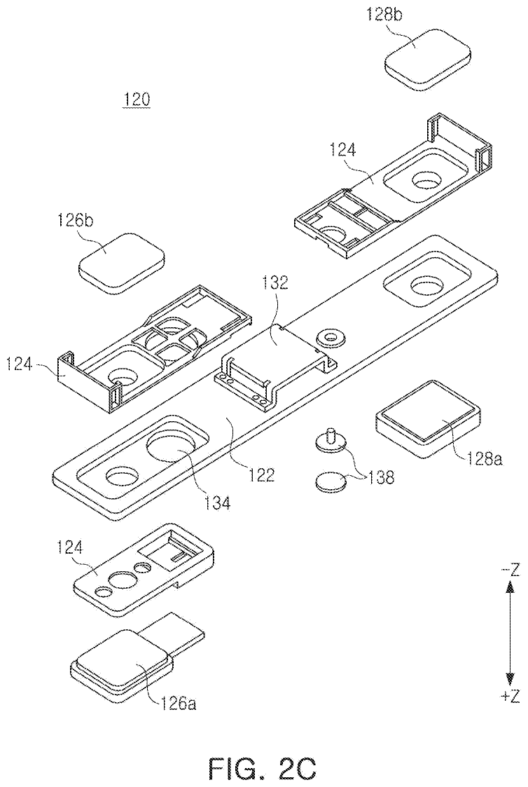

FIGS. 2A, 2B and 2C are views illustrating an upper cap assembly 120. For example, FIG. 2A is an exploded perspective view of the upper cap assembly 120 according to an embodiment of the present disclosure. FIG. 2B is a rear perspective view of the upper cap assembly 120 according to an embodiment of the present disclosure. Description of the upper cap assembly 120 of FIG. 1 may be applied to the upper cap assembly 120 of FIGS. 2A, 2B and 2C.

The upper cap assembly 120 serving as a cover for the prismatic battery cell 100 is a complex assembly including a plurality of welded components. Adhesives may be used instead of welding specific components.

The prismatic battery cell 100 may include the venting portion 130. The venting portion 130 provides overpressure alleviation when temperature and corresponding pressure increase in the prismatic battery cell 100. For example, the venting portion 130 may be activated in a pressure range of 10 to 15 bars. The venting portion 130 may be laser-welded to the upper cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The prismatic battery cell 100 may be filled with an electrolyte. After electrolyte filling, the electrolyte cap 138 may be welded to the upper cap assembly 120 or a locking ball (not shown) may be forced into an opening of the electrolyte cap 138. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126a.

FIGS. 3A to 3F are a view illustrating an assembly process of an upper cap assembly and an electrode assembly according to an embodiment. A battery cell manufacturing process 300 may include an assembly process of the upper cap assembly 120 and the jelly roll 106.

Referring to FIG. 3A, a sealing tape 106a may be attached to the jelly roll 106. According to an embodiment, the sealing tape 106a may cover at least a portion of the jelly roll 106. According to an embodiment, the sealing tape 106a may seal a portion of the jelly roll 106. Referring to FIG. 3B, the jelly roll 106 may be connected to the upper cap assembly 120. For example, a connection component for connecting the jelly roll 106 and the upper cap assembly 120 may be prepared. The upper cap assembly 120 may be closely attached to the jelly roll 106 using the connection component. For example, the cathode terminal 128 of the upper cap assembly 120 may be connected to the cathode foil 112 of the jelly roll 106, and the anode terminal 126 of the upper cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not illustrated, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the upper cap assembly 120 is disposed on the jelly roll 106, at least a portion of the anode foil 110 may be folded. Although not illustrated, when the upper cap assembly 120 is disposed on the jelly roll 106, the cathode foil 112 may also be folded.

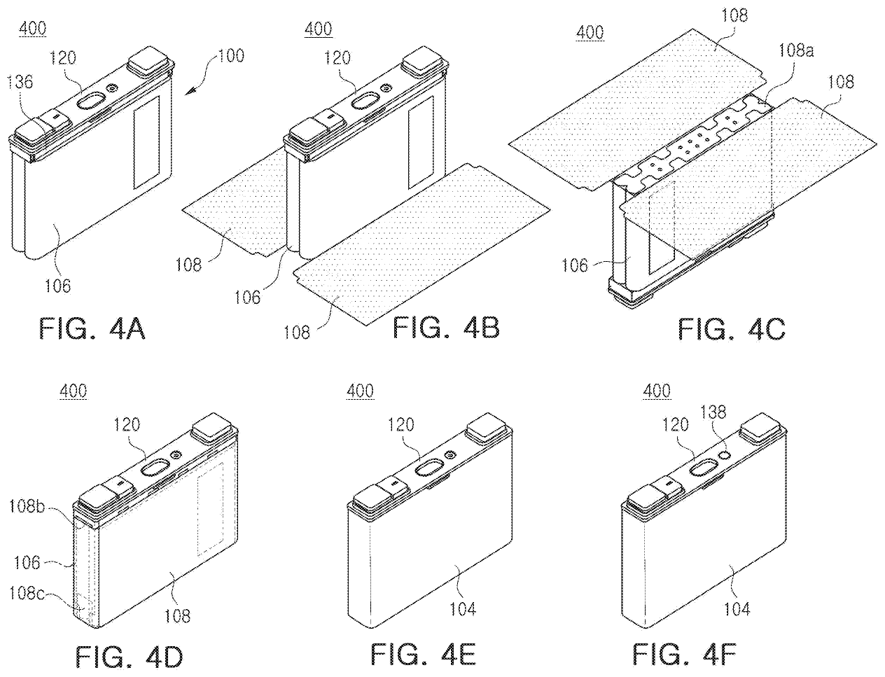

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is illustrated, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the upper cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

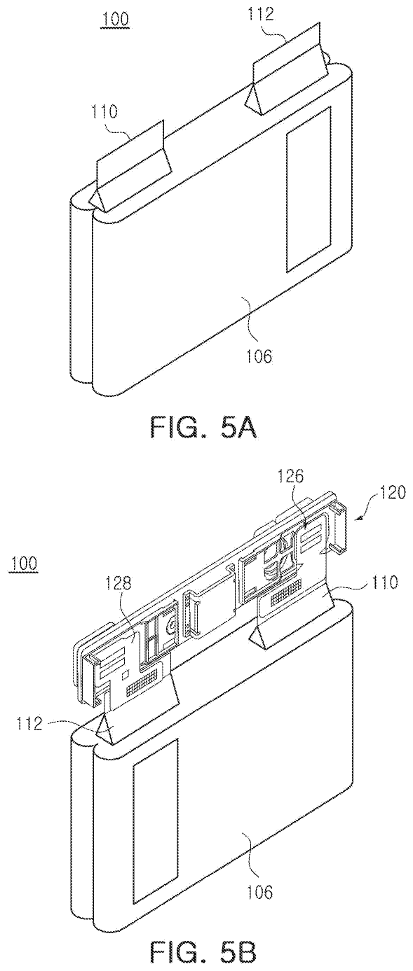

FIGS. 5A and 5B are views illustrating a connection between the jelly roll 106 and the upper cap assembly 120.

Referring to FIGS. 5A and/or 5B, The battery cell 100 may include the jelly roll 106 and/or the upper cap assembly 120. The description of the battery cell 100 of FIG. 1 may be applied to the battery cell 100 of FIGS. 5A and/or 5B. For example, FIG. 5A illustrates the jelly roll 106 having the cathode foil 112 and the anode foil 110. FIG. 5B illustrates connection of the cathode foil 112 to the cathode terminal 128 and connection of the anode foil 110 to the anode terminal 126 on the upper cap assembly 120. For example, the cathode foil 112 may be connected to the second cathode terminal (e.g., the second cathode terminal 128b in FIG. 2C), and the anode foil 110 may be connected to the second anode terminal (e.g., the second anode terminal 126b in FIG. 2C). These provide baseline dimensions that the present disclosure will improve upon to reduce resistance between the anode foil 110 and the anode terminal 126 and/or resistance between the cathode foil 112 and the cathode terminal 128. The dimensions of the anode foil 110 and the cathode foil 112 may be increased to increase a contact area between the anode foil 110 and the anode terminal 126 and/or a contact area between the cathode foil 112 and the cathode terminal 128. The increase in the contact area may lead to a reduction in the resistance.

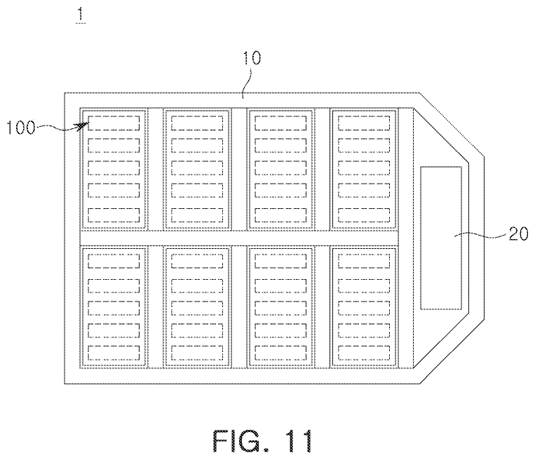

According to an embodiment (e.g., FIG. 11), a battery device (e.g., a battery module, a battery pack, or an energy storage system) including the battery cell 100 may be provided.

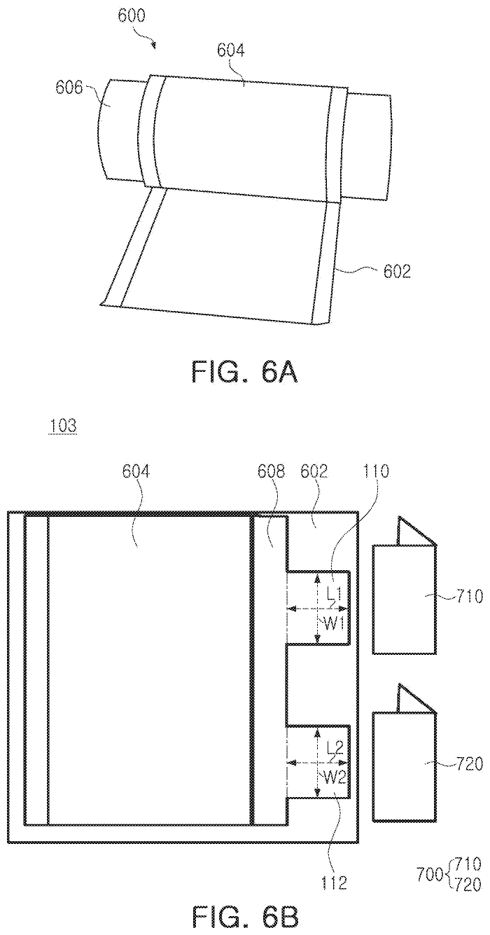

FIG. 6A is a view illustrating a foil roll and die-cutting process according to an embodiment. FIG. 6B illustrates an electrode plate connected to a current collecting structure and including an active material and a foil, according to an embodiment.

FIG. 6A illustrates a standard foil roll and die cutting process. The foil roll 600 may include an active material 604 and a foil 602. The foil 602 may be aluminum for the cathode foil 112 or copper for the anode foil 110. The foil 602 may be coated with the active material 604, such as carbon or lithium. According to an embodiment, the foil 602 may be wrapped around a roll 606. For example, the foil 602 coated with the active material 604 may be wound around the roll 606. As another example, the foil 602 not coated with the active material 604 may be wound around the roll 606 and the active material 604 may be coated while the foil 602 is unwound from the roll 606. In an embodiment, the active material 604 may be referred to as an electrode or electrode plate.

FIG. 6B illustrates a die-cutting process for cutting the cathode foil 112 and the anode foil 110 into desired sizes and shapes. For example, FIG. 6B illustrates an electrode plate 103 including the active material 604, the anode foil 110, and the cathode foil 112. An original shape of the foil 602 is illustrated around a shape of a die-cut foil 608. The die-cutting process is generally incorporated into a roll-to-roll process during which a plurality of dies (not shown) may be used to cut the foil 602 from top to bottom to desired dimensions. For example, the anode foil 110 is manufactured to have a first length L1 and a first width W1, and the cathode foil 112 may be manufactured to have a second length L2 and a second width W2.

According to an embodiment, the battery cell 100 may include a current collecting structure 700 coupled to the foil 602. For example, the current collecting structure 700 may include a first current collecting structure 710 connected to the anode foil 110 and a second current collecting structure 720 connected to the cathode foil 112. For example, the anode foil 110 may be crimped and welded to the first current collecting structure 710 and the cathode foil 112 may be crimped and welded to the second current collecting structure 720.

In an embodiment, the current collecting structure 700 may be referred to as a clamping structure, a crimp structure, or a connection structure. In an embodiment, the first current collecting structure 710 may be referred to as an anode clamping structure or an anode crimp structure. The second current collecting structure 720 may be referred to as a cathode clamping structure or a cathode crimp structure.

Although the anode foil 110 and the cathode foil 112 are illustrated in the same layer in FIG. 6B, the anode foil 110 is spaced apart from the cathode foil 112. For example, the battery cell (e.g., the battery cell 100 of FIG. 1) includes a separator (not shown) located between the anode foil 110 and the cathode foil 112. Contact between the anode foil 110 and the cathode foil 112 may be prevented by the separator.

Although FIG. 6B illustrates the active material 604 disposed on the foil 602 or the die-cut foil 608, the active material 604 may include a positive electrode active material applied on the anode foil 110 and a negative electrode active material applied on the cathode foil 112.

According to an embodiment, the positive electrode active material may include a material (e.g., slurry) capable of providing lithium ions. For example, the positive electrode active material may include at least one of nickel cobalt manganese, nickel cobalt aluminum, lithium iron phosphate, lithium manganese oxide, or lithium cobalt oxide.

According to an embodiment, the negative electrode active material may include a material (e.g., slurry) capable of storing or releasing lithium ions transferred from the positive electrode active material. For example, the negative electrode active material may include at least one of graphite, graphene, silicon dioxide, titanium dioxide, or lithium titanate.

In this document, the anode foil 110 and the cathode foil 112 may be referred to as an uncoated portion of the foil 602 coated with the negative electrode active material and an uncoated portion of the foil 602 coated with the positive electrode active material, respectively.

In FIG. 6B, for convenience of description, some components (e.g., the separator) are excluded. For example, the anode foil 110 and the cathode foil 112 are illustrated as a single foil 602, but those skilled in the art will appreciate a structure in which the anode foil 110 and the cathode foil 112 are separated.

The first length L1 and the first width W1 of the anode foil 110 illustrated in FIG. 6B may refer to a length and width of the uncoated portion (the portion to which the active material 604 is not applied) of the anode foil 110. The description of the anode foil 110 may be applied to the cathode foil 112 as well.

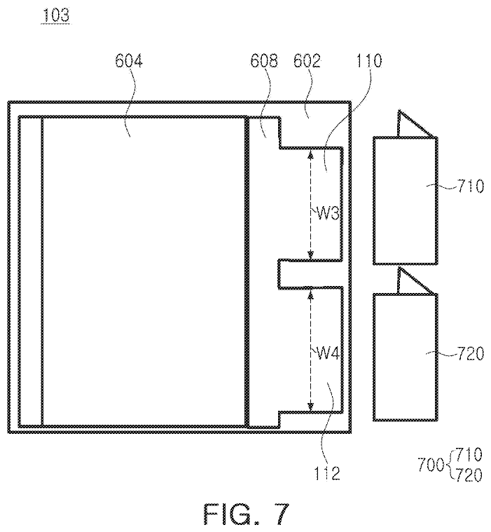

FIG. 7 illustrates an electrode plate connected to a current collecting structure and including an active material and a foil, according to an embodiment.

Referring to FIG. 7, the electrode plate 103 may include the anode foil 110 and the cathode foil 112. The electrode plate 103 may be connected to the current collecting structure 700. The description of the foil 602, the active material 604, the die-cut foil 608, the anode foil 110, the cathode foil 112, and the current collecting structure 700 of FIG. 6B may be applied to the foil 602, the active material 604, the die-cut foil 608, the anode foil 110, the cathode foil 112, and the current collecting structure 700 of FIG. 7.

According to an embodiment, the electrode plate 103 may have a shape for reducing resistance between the anode foil 110 and the anode terminal (e.g., the anode terminal 126 in FIG. 1) and/or resistance between the cathode foil 112 and the cathode terminal (e.g., the cathode terminal 128 in FIG. 1). For example, the anode foil 110 and the cathode foil 112 may have a structure for increasing a surface area. By increasing the surface area of the anode foil 110 and the cathode foil 112, less energy may be consumed when heat is generated. As the energy consumption is reduced, resistance of the anode foil 110 and the cathode foil 112 may be reduced.

The widths of the anode foil 110 and cathode foil 112 may be selectively designed. According to an embodiment, the widths of the anode foil 110 and the cathode foil 112 may be changed by a die cutting process. For example, a third width W3 of the anode foil 110 of FIG. 7 may be greater than the first width W1 of the anode foil 110 of FIG. 6B.

A fourth width W4 of the cathode foil 112 of FIG. 7 may be greater than the second width W2 of the anode foil 110 of FIG. 6B. As the third width W3 of the anode foil 110 and/or the fourth width W4 of the cathode foil 112 increase, a contact area between the anode foil 110 and the first current collecting structure 710 and/or a contact area between the cathode foil 112 and the second current collecting structure 720 may increase. By increasing the contact areas, resistance may decrease and a voltage drop across the foil portions 110 and 112 and the current collecting structures 710 and 720 may decrease.

According to an embodiment, the current collecting structure 700 may be designed to correspond to the structures of the foil portions 110 and 112. For example, the width of the current collecting structure 700 may be formed to correspond to the third width W3 of the anode foil 110 and the fourth width W4 of the cathode foil 112.

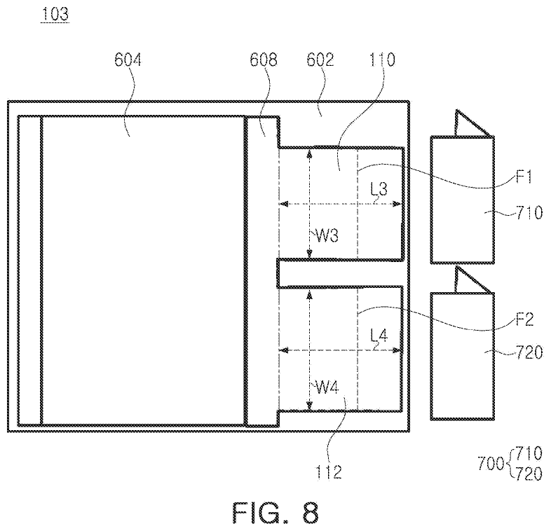

FIG. 8 illustrates an electrode plate connected to a current collecting structure and including a folded foil, according to an embodiment.

Referring to FIG. 8, the electrode plate 103 may include the anode foil 110 and the cathode foil 112. The electrode plate 103 may be connected to the current collecting structure 700. The description of the foil 602, the active material 604, the die-cut foil 608, the anode foil 110, the cathode foil 112, and the current collecting structure 700 of FIG. 6B or FIG. 7 may be applied to the foil 602, the active material 604, the die-cut foil 608, the anode foil 110, the cathode foil 112, and the current collecting structure 700 of FIG. 8.

According to an embodiment, at least a portion of the electrode plate 103 of FIG. 8 may be folded. For example, the electrode plate 103 of FIG. 8 may include the anode foil 110 and the cathode foil 112 in which at least a portion (e.g., an uncoated portion) is folded. The anode foil 110 may be folded based on a first folding line F1. The cathode foil 112 may be folded based on a second folding line F2. The first folding line F1 may be substantially perpendicular to a direction in which the anode foil 110 extends. The second folding line F2 may be substantially perpendicular to a direction in which the cathode foil 112 extends.

According to an embodiment, the anode foil 110 and the cathode foil 112 may be formed to be longer than normal foil portions. A third length L3 may be 125 to 200% of the first length L1 of FIG. 6B. The first length L1 may be a general length of the anode foil 110. A fourth length L4 may be 125 to 200% of the second length L2 of the cathode foil 112 of FIG. 6B. The second length L2 may be a general length of the cathode foil 112. According to an embodiment, by increasing the lengths of the anode foil 110 and the cathode foil 112, a folding process of the anode foil 110 and the cathode foil 112 may be easily performed.

According to an embodiment, the electrode plate 103 may be manufactured by a die-cut process for the foil 602 at least partially folded. In an embodiment, after die cutting, the anode foil 110 and the cathode foil 112 may be folded based on the first folding line F1 and the second folding line F2, respectively. In an embodiment, the process of folding the foil portions 110 and 112 may be performed using a bar or rod placed along the folding lines F1 and F2.

A folding mechanism (not shown) may refer a process or structure for folding the foil portions 110 and 112 before crimping the foil portions 110 and 112 with the current collecting structure 700. The folding mechanism may include a tool (e.g., a bar, rod, or robot) (not shown) for folding the foil portions 110 and 112.

According to an embodiment, by folding the anode foil 110 and the cathode foil 112, a cross-sectional area of the anode foil 110 and the cathode foil 112 and/or a volume of the conductive material may increase and resistance occurring in the anode foil 110 and the cathode foil 112 may decrease.

As the anode foil 110 and the cathode foil 112 are folded, the volume of the conductive material inside the current collecting structure 700 may increase. As the volume of the conductive material increases, resistance may decrease in connection between the jelly roll (e.g., the jelly roll 106 of FIG. 1) and the upper cap assembly (e.g., the upper cap assembly 120 of FIG. 1).

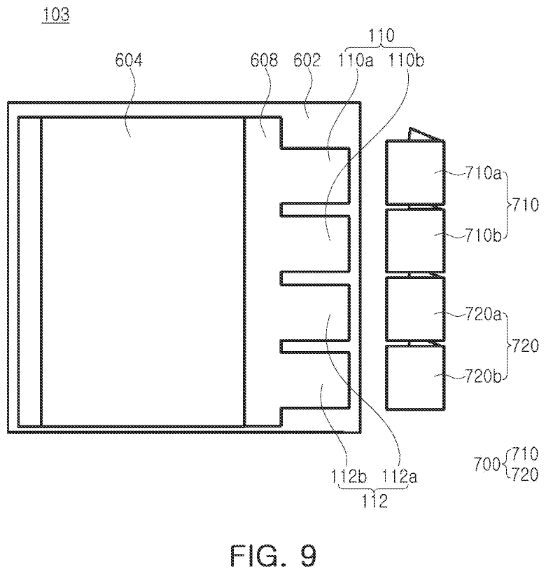

FIG. 9 illustrates an electrode plate including a plurality of uncoated portions, according to an embodiment.

Referring to FIG. 9, the electrode plate 103 may include the anode foil 110 and the cathode foil 112. The electrode plate 103 may be connected to the current collecting structure 700.

The description of the foil 602, the active material 604, the die-cut foil 608, the anode foil 110, the cathode foil 112, and the current collecting structure 700 of FIGS. 6B, 7, and/or 8 may be applied to the foil 602, the active material 604, the die-cut foil 608, the anode foil 110, the cathode foil 112, and the current collecting structure 700 of FIG. 9.

According to an embodiment, the anode foil 110 and the cathode foil 112 may include a plurality of uncoated portions 110a, 110b, 112a, and 112b. The uncoated portions 110a, 110b, 112a, and 112b may be referred to as electrode tabs.

In an embodiment, one anode foil 110 may include a plurality of uncoated portions 110a and 110b to which the active material 604 is not applied. For example, the anode foil 110 may include a first uncoated portion 110a and a second uncoated portion 110b spaced apart from the first uncoated portion 110a.

In an embodiment, the cathode foil 112 may include a plurality of uncoated portions 112a and 112b to which the active material 604 is not applied. For example, the cathode foil 112 may include a third uncoated portion 112a and a fourth uncoated portion 112b spaced apart from the third uncoated portion 112a.

Since the anode foil 110 and the cathode foil 112 include a plurality of uncoated portions 110a, 110b, 112a, and 112b, a contact area between the anode foil 110 and the anode terminal 126 and a contact area between the cathode foil 112 and the cathode terminal 128 may increase. Since the contact area increases, resistance in the circuit may decrease.

According to an embodiment, the anode foil 110 and/or the cathode foil 112 may be cut through a die-cutting process. For example, by the die cutting process, the anode foil 110 may be formed to have the first uncoated portion 110a and the second uncoated portion 110b. The cathode foil 112 may be formed to have the third uncoated portion 112a and the fourth uncoated portion 112b.

The current collecting structure 700 may include a plurality of current collecting structures 700. For example, the current collecting structure 700 may include a first current collecting structure 710 connected to the anode foil 110 and a second current collecting structure 720 connected to the cathode foil 112. The first current collecting structure 710 may include a first anode current collecting structure 710a connected to the first uncoated portion 110a and a second anode current collecting structure 710b connected to the second uncoated portion 110b. The second current collecting structure 720 may include a first cathode current collecting structure 720a connected to the third uncoated portion 112a and a second cathode current collecting structure 720b connected to the fourth uncoated portion 112b. According to an embodiment, the magnitude of resistance occurring in the electrode plate 103 may be reduced by using the plurality of current collecting structures 700. According to an embodiment, the first anode current collecting structure 710a and the second anode current collecting structure 710b may be connected to an anode terminal (e.g., the second anode terminal 126b of FIG. 2A). According to an embodiment, the first cathode current collecting structure 720a and the second cathode current collecting structure 720b may be connected to a cathode terminal (e.g., the second cathode terminal 128b of FIG. 2A). According to an embodiment, a plurality of anode current collecting structures 710a and 710b may be connected to one anode terminal 126 and a plurality of cathode current collecting structures 720a and 720b may be connected to one cathode terminal 128.

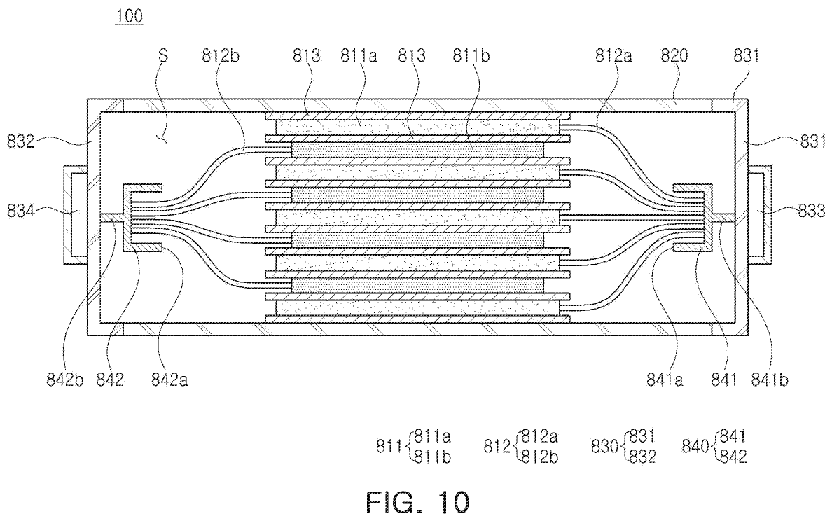

FIG. 10 is a schematic diagram of a battery cell, according to an embodiment.

Referring to FIG. 10, a battery cell 100 may include an electrode assembly 810, a case 820, a cap assembly 830, and a current collecting structure 840.

According to an embodiment, the electrode assembly 810 may include at least one negative electrode plate, at least one positive electrode plate, and at least one separator 813. The at least one negative electrode plate may include an anode foil 812a and a negative electrode active material 811a coated on the anode foil 812a. The at least one positive electrode plate may include a cathode foil 812b and a positive electrode active material 811b coated on the cathode foil 812b.

The structure of the electrode assembly 810 may be selectively designed. For example, although the electrode assembly 810 including stacked electrode plates is illustrated in FIG. 10, the structure of the electrode assembly 810 is not limited thereto. For example, the description of the jelly roll 106 of FIG. 1 may be applied to the electrode assembly 810 of FIG. 10.

According to an embodiment, the case 820 may provide an accommodating space S for accommodating the electrode assembly 810. The accommodating space S may accommodate an electrolyte solution (not shown) and the electrode assembly 810. Description of the can 104 of FIG. 1 may be applied to the case 820 of FIG. 10.

The shape of the case 820 may be selectively designed. For example, according to an embodiment (e.g., FIG. 10), the case 820 may have a through shape to be connected to a plurality of cap assemblies 831 and 832.

According to an embodiment, the cap assembly 830 may include a first cap assembly 831 and a second cap assembly 832. The first cap assembly 831 may be connected to a first end portion (e.g., the end portion located on the right side of the case 820 in FIG. 10) of the case 820, and the second cap assembly 832 may be connected to a second end portion (e.g., the end portion located on the left side of case 820 in FIG. 10). According to an embodiment, the battery cell 100 may include terminals 833 and 834 located in both directions. For example, the first cap assembly 831 may include a first terminal 833, and the second cap assembly 832 may include a second terminal 834. The first terminal 833 may be an anode terminal (e.g., the anode terminal 126 of FIG. 1). The second terminal 834 may be a cathode terminal (e.g., the cathode terminal 128 of FIG. 1). According to another embodiment (e.g., FIG. 1), the case 820 may include a recess formed to be connected to one cap assembly (e.g., the cap assembly 120 of FIG. 1). According to an embodiment, at least a portion of the description of the upper cap assembly 120 of FIGS. 2A, 2B and/or 2C may be applied to the cap assembly 830 of FIG. 10.

According to an embodiment, the current collecting structure 840 may electrically connect the electrode assembly 810 and the terminals 833 and 834. For example, the current collecting structure 840 may be connected to the foil portions 812a and 812b of the electrode assembly 810 and the terminals 833 and 834 of the cap assembly 830. For example, the current collecting structure 840 may include a first current collecting structure 841 connected to the anode foil 812a and anode terminal 833 and a second current collecting structure 842 connected to the cathode foil 812b and the cathode terminal 834. The description of the current collecting structure 700 of FIGS. 6B to 9 may be applied to the current collecting structure 840 of FIG. 10. According to an embodiment, the current collecting structure 840 may be formed of a conductive metal. The current collecting structure 840 may be bonded to the foil portions 110 and 112 and the terminals 833 and 834.

According to an embodiment, the current collecting structure 840 may have a shape for connecting the plurality of foil portions 812a and 812b. For example, the current collecting structure 840 may include clamping portions 841a and 842a pressing the foil (e.g., the anode foil 812a or the cathode foil 812b). The current collecting structure 840 may include connection portions 841b and 842b extending from the clamping portions 841a and 842a. The connection portions 841b and 842b may be bonded to terminals (e.g., the anode terminal 833 or the cathode terminal 834).

According to an embodiment, the electrode assembly 810 may include a plurality of anode foils 812a and a plurality of cathode foils 812b, and the clamping portions 841a and 842a may be coupled, while providing pressure to the plurality of anode foils 812a or the plurality of cathode foils 812b. For example, the clamping portions 841a and 842a of the current collecting structure 840 may include a hinge structure (not shown) or an elastic structure (not shown), and provide pressure so that the plurality of anode foils 812 or the plurality of cathode foils are brought into contact with each other.

According to an embodiment, the current collecting structure 840 may include a first clamping portion 841a configured to bring end portions of the plurality of anode foils 812a into close contact with each other and a second clamping portion 842a configured to bring end portions of the plurality of cathode foils 812b into close contact with each other.

The plurality of anode foils 812a or the plurality of cathode foils 812b may be accommodated in the clamping portions 841a and 842a and electrically connected to the clamping portions 841a and 842a. According to an embodiment, the clamping portions 841a and 842a may be referred to as a crimp structure or a clamping structure. According to an embodiment, the connection portions 841b and 842b may be electrically connected to the anode terminal 833 or the cathode terminal 834.

The current collecting structure 840 may include a plurality of current collecting structures 841 and 842. According to an embodiment, the first current collecting structure 841 may include a first clamping portion 841a connected to the plurality of anode foils 841a and a first extending portion 841b extending from the first clamping portion 841a. The second current collecting structure 842 may include a second clamping portion 842a connected to the plurality of cathode foils 812b and a second extending portion 842b extending from the second clamping portion 842a.

FIG. 11 is a schematic diagram of a battery device including battery cells, according to an embodiment.

Referring to FIG. 11, the battery device 1 may include a plurality of battery cells 100. The battery device 1 of FIG. 11 may be an energy storage device. However, the battery device 1 is not limited thereto. For example, the battery device 1 may be a battery pack or a battery module. The description of the battery cell 100 of FIGS. 1 to 10 may be applied to the battery cell 100 of FIG. 11.

Referring to FIG. 11, the battery device 1 may include a housing 10 providing a space in which the plurality of battery cells 100 are accommodated. For example, the plurality of battery cells 100 may be arranged in respective spaces partitioned by the housing 100. The plurality of battery cells 100 arranged respectively in the partitioned spaces of the housing 10 may become one battery module.

The battery device 10 may include a battery management system (BMS) 20 for controlling the plurality of battery cells 100 or the battery module. The battery management system 20 may be disposed within the housing 10.

A structure of the housing 10 may be selectively designed. For example, the shape of the housing 10 may be selectively changed. In an embodiment, the housing 10 may include a cover (not shown) covering the plurality of battery cells 100.

The functions performed in the processes and methods may be implemented in a different order. In addition, the schematic operations and actions are provided as examples only, and some of the operations and actions may be optional, combined into fewer operations and actions, or extended to additional operations and actions without detracting from the essence of the disclosed embodiments.

According to an embodiment of the present disclosure, an increase in resistance and heat generation due to current bottleneck may be reduced.

According to an embodiment of the present document, since an overheated battery cell is detected or monitored using the thermochromic member, operator convenience for replacing a battery cell in which an event occurs may be improved. In addition, test costs may be reduced and quality of the battery device may be improved.

Only specific examples of implementations of certain embodiments are described. Variations, improvements and enhancements of the disclosed embodiments and other embodiments may be made based on the disclosure of this patent document.

What is claimed is:

1. A battery cell comprising:
an electrode assembly including an active material and a foil;
a case accommodating the electrode assembly;
a cap assembly connected to the case and including a terminal; and
a current collecting structure connecting the foil to the terminal.

2. The battery cell of claim 1, wherein
the foil includes a plurality of anode foils and a plurality of cathode foils,
the terminal includes an anode terminal and a cathode terminal, and
the current collecting structure includes a first current collecting structure connected to the plurality of anode foils and the anode terminal and a second current collecting structure connected to the plurality of cathode foils and the cathode terminal.

3. The battery cell of claim 1, wherein the current collecting structure includes a clamping portion connected to the foil and a connection portion extending from the clamping portion and contacting the terminal.

4. The battery cell of claim 1, wherein the foil is formed to be at least partially folded, and the current collecting structure is connected to the folded foil.

5. The battery cell of claim 1, wherein
the foil includes an anode foil including a first uncoated portion and a second uncoated portion and a cathode foil including a third uncoated portion and a fourth uncoated portion, and
the current collecting structure includes a first current collecting structure connected to the anode foil and a second current collecting structure connected to the cathode foil.

6. The battery cell of claim 5, wherein
the first current collecting structure includes a first anode current collecting structure connected to the first uncoated portion and a second anode current collecting structure connected to the second uncoated portion and spaced apart from the first anode current collecting structure, and
the second current collecting structure includes a first cathode current collecting structure connected to the third uncoated portion and a second cathode current collecting structure connected to the fourth uncoated portion and spaced apart from the first cathode current collecting structure.

7. The battery cell of claim 6, wherein the terminal includes an anode terminal connected to the first anode current collecting structure and the second anode current collecting structure, and a cathode terminal connected to the first cathode current collecting structure and the second cathode current collecting structure.

8. The battery cell of claim 1, further comprising the current collecting structure is formed of a conductive metal.

9. The battery cell of claim 1, wherein
the cap assembly includes a first cap assembly connected to a first end portion of the case and including a first terminal, and a second cap assembly connected to a second end portion of the case opposite to the first end portion and including a second terminal, and
the current collecting structure includes a first current collecting structure connected to the first terminal and a second current collecting structure connected to the second terminal.

10. The battery cell of claim 1, wherein
the cap assembly includes a base plate attached to the case, a first terminal at least partially exposed to the outside of the base plate, and a second terminal spaced apart from the first terminal and at least partially exposed to the outside of the base plate, and
the current collecting structure includes a first current collecting structure connected to the first terminal and a second current collecting structure connected to the second terminal.

11. The battery cell of claim 1, wherein the cap assembly includes a base plate attached to the case and an insulator at least partially located between the base plate and the terminal.

12. The battery cell of claim 11, wherein the cap assembly includes a venting portion, and a vent guard connected to the base plate and protecting the venting portion.

13. The battery cell of claim 1, wherein
the foil includes a plurality of anode foils and a plurality of cathode foils,
the current collecting structure includes a first current collecting structure connected to the plurality of anode foils and a second current collecting structure connected to the plurality of cathode foils, and
the terminal includes:
an anode terminal including a first anode terminal at least partially exposed to the outside of the battery cell and a second anode terminal connected to the first anode terminal and the first current collecting structure and
a cathode terminal including a first cathode terminal at least partially exposed to the outside of the battery cell and a second cathode terminal connected to the first cathode terminal and the second current collecting structure.

14. The battery cell of claim 13, wherein the current collecting structure includes a first clamping portion configured to bring end portions of the plurality of anode foils into close contact with each other and a second clamping portion configured to bring end portions of the plurality of cathode foils into close contact with each other.

15. A battery device comprising the battery cell of claim 1.
